(19) United States
(12) Patent Application Publication
(10) Pub. No.: US 2009/0171811 A1
(43) Pub. Date: Jul. 2, 2009

(54) Architectural Design For Product Catalog Management Application Software

(76) Inventors: Markus A. Peter, St. Leon-Rot (DE); Michael Oemler, Neckargemuend (DE); Juergen Lange, Heidelberg (DE); Thomas Maag, Reilingen (DE)

Correspondence Address: FISH & RICHARDSON, P.C., PO BOX 1022, MINNEAPOLIS, MN, 55440-1022, US

(21) Appl. No.: 11/967,387

(22) Filed: Dec. 31, 2007

(51) Int. Cl. G06Q 30/00

(52) U.S. Cl. 705/27; 705/1

(57) ABSTRACT

Methods, systems, and apparatus, including computer program products, for implementing a software architecture design for a software application implementing product catalog management. The application is structured as multiple process components interacting with each other through service interfaces, and multiple service operations, each being implemented for a respective process component. The process components include a product catalog authoring process component that creates and edits a product catalog; a product catalog publishing process component that provides a released product catalog in electronic form; and a purchasing contract processing process component that creates and maintains purchasing contracts.

### BACKGROUND

The subject matter of this patent application relates to computer software architecture, and, more particularly, to the architecture of application software for product catalog management.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a product catalog management software application.

In various aspects, the subject matter described in this specification can be implemented as methods, systems, and apparatus, including computer program products, for implementing a software architecture design for a software application implementing product catalog management. The application is structured as multiple process components interacting with each other through service operations, each implemented for a respective process component. The process components include a Product Catalog Authoring process component and a Product Catalog Publishing process component.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a product catalog management software application.

FIG. 2 illustrates the elements of the architecture as they are drawn in the figures.

FIG. 3 is a block diagram showing interactions between a Purchasing Contract Processing process component and a Product Catalog Authoring process component.

FIGS. 4A and 4B are block diagrams collectively showing interactions between a Product Catalog Authoring process component and a Product Catalog Publishing process component.

FIG. 5 is a block diagram showing interactions between a Product Catalog Authoring process component and a Product Catalog Authoring at Customer process component.

FIG. 6 is a block diagram showing interactions between a Product Catalog Authoring at Supplier process component and a Product Catalog Authoring process component.

### DETAILED DESCRIPTION

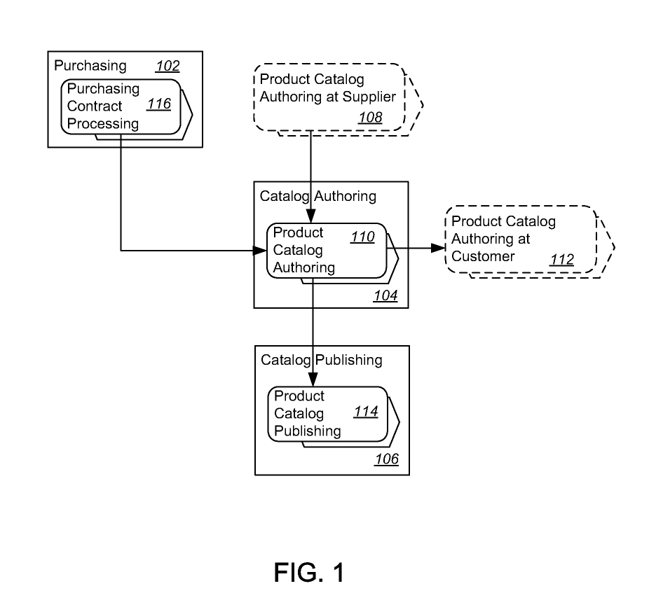

FIG. 1 shows the software architectural design for a product catalog management software application. The product catalog management application is software that implements creation of a new catalog or the update of a published catalog based on product master data changes or based on catalogs from external suppliers.

As shown in FIG. 1, the product catalog management design includes three deployment units: a Purchasing deployment unit 102, a Catalog Authoring deployment unit 104, and a Catalog Publishing deployment unit 106.

The Purchasing deployment unit 102 includes a Purchasing Contract Processing process component 116 that creates and maintains purchasing contracts.

The Catalog Authoring deployment unit 104 includes a Product Catalog Authoring process component 110 that creates and edits product catalogs, which includes collecting information from the relevant sources, checking the quality of the catalog content, and determining when and to what extent the catalogs are published for use in other business processes.

The Catalog Publishing deployment unit 106 includes a Product Catalog Publishing process component 114. The Product Catalog Publishing process component 114 provides released product catalogs in electronic form. The electronic form can include various search mechanisms for finding items in these catalogs and mechanisms for transferring items to other applications.

A number of external process components will be used to describe the architectural design. The external process components include a Product Catalog Authoring at Supplier process component 108 and a Product Catalog Authoring at Customer process component 112. The Product Catalog Authoring process component 110 receives messages from the Product Catalog Authoring at Supplier process component 108. The Product Catalog Authoring at Customer process component 112 receives messages from Product Catalog Authoring process component 110.

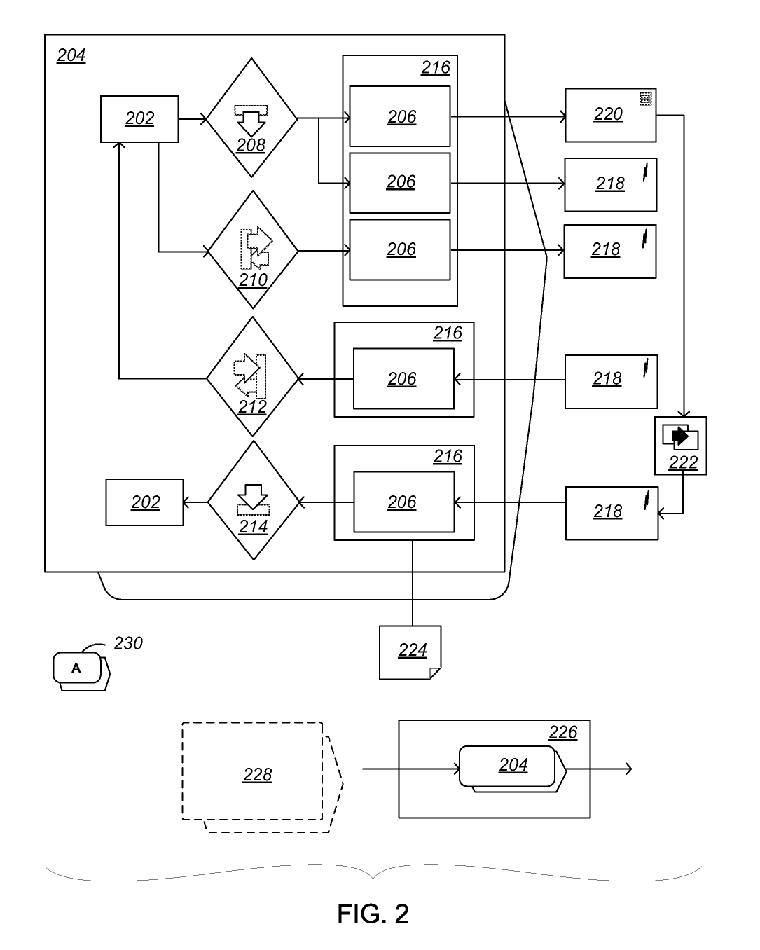

FIG. 2 illustrates the elements of the architecture as they are drawn in the figures of this patent application. The elements of the architecture include the business object 202, the process component 204, the operation 206, the outbound process agent 208, the synchronous outbound process agent 210, the synchronous inbound process agent 212, the inbound process agent 214, the service interface or interface 216, the message 218, the form message 220, the mapping entity 222, the communication channel template 224, and the deployment unit 226.

Not explicitly represented in the figures is a foundation layer that contains all fundamental entities that are used in multiple deployment units 226. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

A process component of an external system is drawn as a dashed-line process component 228. Such a process component 228 represents the external system in describing interactions with the external system; however, the process component 228 need not represent more of the external system than is needed to produce and receive messages as required by the process component that interacts with the external system.

The connector icon 230 is used to simplify the drawing of interactions between process components 204. Interactions between process component pairs 204 involving their respective business objects 202, process agents (at 208, 210, 212, and 214), operations 206, interfaces 216, and messages (at 218 and 22) are described as process component interactions, which determine the interactions of a pair of process components across a deployment unit boundary, i.e., from one deployment unit 226 to another deployment unit 226. Interactions between process components 204 are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components 204, but interfaces 216, process agents (at 208, 210, 212, and 214), and business objects 202 that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component 204 is described as being contained in a deployment unit 226. It should be understood, however, that such operational inclusion can be realized in a variety of ways and is not limited to a physical inclusion of the entirety of one element in another.

The architectural elements include the business object 202. A business object 202 is a representation of a type of a uniquely identifiable business entity (an object instance) described by a structural model. Processes operate on business objects. This example business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component 204, is an object that encapsulates transactional data (i.e., data that is valid for a point in time). The term business object will be used generically to refer to a business process object and a master data object, unless the context requires otherwise. Properly implemented, business objects 202 are implemented free of redundancies.

The architectural elements also include the process component 204. A process component 204 is a software package that realizes a business process and generally exposes its functionality as services. The functionality includes the ability to perform all or parts of particular kinds of business transactions. A process component 204 contains one or more semantically related business objects 202. Any business object belongs to no more than one process component. Process components can be categorized as a standard process component, a process component at a business partner, a third party process component, or a user centric process component. The standard process component (named simply process component) is a software package that realizes a business process and exposes its functionality as services. The process component at a business partner is a placeholder for a process component (or other technology that performs the essential functions of the process component) used at a business partner. The third party process component is a process component (or other technology that performs the essential functions of the process component) provided by a third party. The user centric process component is a process component containing user interface parts.

Process components 204 are modular and context-independent. That they are context-independent means that a process component 204 is not specific to any specific application and is reusable. The process component 204 is often the smallest (most granular) element of reuse in the architecture.

The architectural elements also include the operation 206. An operation 206 belongs to exactly one process component 204. A process component 204 generally is able to perform multiple operations 206. Operations 206 can be synchronous or asynchronous, corresponding to synchronous or asynchronous process agents (e.g. at 208, 210, 212, and 214), which will be described below. Operation 206 may be the smallest, separately-callable function, described by a set of data types used as input, output, and fault parameters serving as a signature.

The architectural elements also include the service interface 216, referred to simply as the interface. An interface 216 is a named group of operations 206. Interface 216 typically specifies inbound service interface functionality or outbound service interface functionality. Each operation 206 belongs to exactly one interface 216. An interface 216 belongs to exactly one process component 204. A process component 204 might contain multiple interfaces 216. In some implementations, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations 206 directed to the same other process component 204 are in one interface 216.

The architectural elements also include the message 218. Operations 206 transmit and receive messages 218. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component. In some implementations, the message is a form based message 220 that can be translated into a recognized format for an external process component 228. The form message type 220 is a message type used for documents structured in forms. The form message type 220 can be used for printing, faxing, emailing, or other events using documents structured in forms. In some implementations, the form message type 220 provides an extended signature relative to the normal message type. For example, the form message type 220 can include text information in addition to identification information to improve human reading.

The architectural elements also include the process agent (e.g. at 208, 210, 212, and 214). Process agents do business processing that involves the sending or receiving of messages 218. Each operation 206 will generally have at least one associated process agent. The process agent can be associated with one or more operations 206. Process agents (at 208, 210, 212, and 214) can be either inbound or outbound, and either synchronous or asynchronous.

Asynchronous outbound process agents 208 are called after a business object 202 changes, e.g., after a create, update, or delete of a business object instance. Synchronous outbound process agents 210 are generally triggered directly by a business object 202.

An outbound process agent (208 and 210) will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents (212 and 214) are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents (210 and 212) are used when a process component requires a more or less immediate response from another process component, and is waiting for that response to continue its work.

Operations and process components are described in this specification in terms of process agents. However, in alternative implementations, process components and operations can be implemented without use of agents by using other conventional techniques to perform the functions described in this specification.

The architectural elements also include the communication channel template. The communication channel template is a modeling entity that represents a set of technical settings used for communication. The technical settings can include details for inbound or outbound processing of a message. The details can be defined in the communication channel template. In particular, the communication channel template defines an adapter type, a transport protocol, and a message protocol. In some implementations, various other parameters may be defined based on a selected adapter type. For example, the communication channel template can define a security level, conversion parameters, default exchange infrastructure parameters, processing parameters, download URI parameters, and specific message properties.

The communication channel template 224 can interact with internal or external process components (at 204 and 228). To interact with an internal process component, the communication channel template is received and uploaded to be used with an operation and interface pair. To interact with an external process component, the communication channel template is received and uploaded to be used with an external entity, such as an external bank, business partner, or supplier.

The architectural elements also include the deployment unit 226. A deployment unit 226 includes one or more process components 204 that are deployed together on a single computer system platform. Conversely, separate deployment units can be deployed on separate physical computing systems. For this reason, a boundary of a deployment unit 226 defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components 204 of one instance of one deployment unit 226.

The process components 204 of one deployment unit 226 interact with those of another deployment unit 226 using messages 218 passed through one or more data communication networks or other suitable communication channels. Thus, a deployment unit 226 deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units 226 is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components 204 that interact with other process components 204 or external systems only through messages 218, e.g., as sent and received by operations 206, can also be replaced as long as the replacement supports the operations 206 of the original 204.

In contrast to a deployment unit 226, the foundation layer does not define a limit for application-defined transactions. Deployment units 226 communicate directly with entities in the foundation layer, which communication is typically not message based. The foundation layer is active in every system instance on which the application is deployed. Business objects 202 in the foundation layer will generally be master data objects. In addition, the foundation layer will include some business process objects that are used by multiple deployment units 226. Master data objects and business process objects that should be specific to a deployment unit 226 are assigned to their respective deployment unit 226.

### Interactions Between Process Components “Purchasing Contract Processing” and “Product Catalog Authoring”

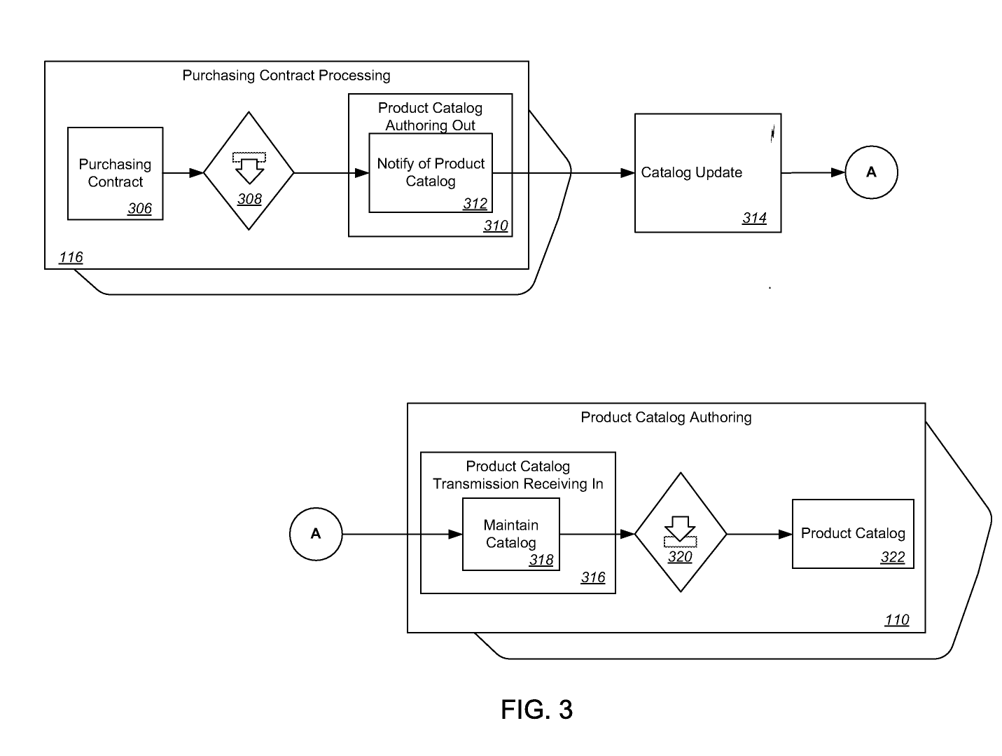

FIG. 3 is a block diagram showing example interactions between the Purchasing Contract Processing process component 116 and the Product Catalog Authoring process component 110 in the architectural design of FIG. 1. The interactions include sending of data by the purchasing contract processing to modify a product catalog. The interaction starts when a status for a good or service product is set to “released.”

As shown in FIG. 3, the Purchasing Contract Processing process component 116 includes a Purchasing Contract business object 306. The Purchasing Contract business object 306 represents a legally binding purchase agreement that contains special conditions that are negotiated between a buyer and a seller, covering goods to be supplied or services to be performed. The purchase agreement may be valid for a specific period of time, during which goods and services are released against the contract.

The Purchasing Contract business object 306 uses a Notify of Product from Purchasing Contract to Product Catalog Authoring outbound process agent 308 to invoke a Notify of Product Catalog operation 312. The Notify of Product Catalog operation 312 sends data to create or update items in catalog authoring from a released purchasing contract to the Product Catalog Authoring process component 110. The operation 312 is included in a Product Catalog Authoring Out interface 310. The operation 312 generates a Catalog Update message 314.

A Maintain Catalog operation 318 receives the Catalog Update message 314. The operation 318 is included in a Product Catalog Transmission Receiving In interface 316. The operation 318 creates a new catalog or changes or deletes an existing catalog. The Maintain Catalog operation 318 uses a Maintain Product Catalog inbound process agent 320 to update a Product Catalog business object 322. The Product Catalog business object 322 represents a structured directory of catalog items, where each catalog item represents and may provide information about a product.

### Interactions Between Process Components “Product Catalog Authoring” and “Product Catalog Publishing”

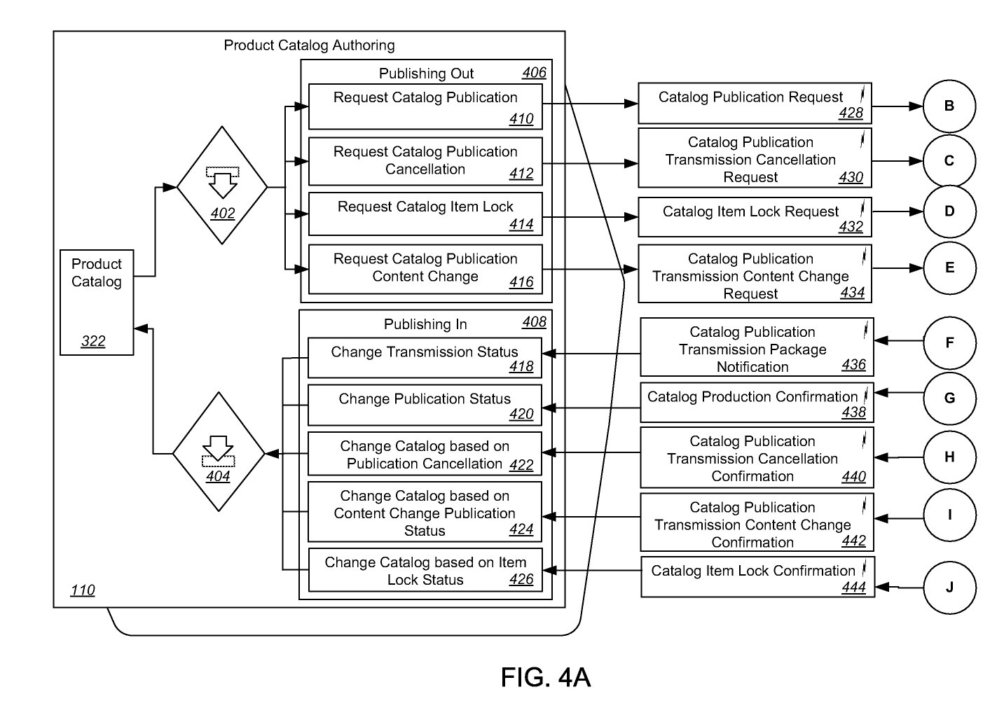

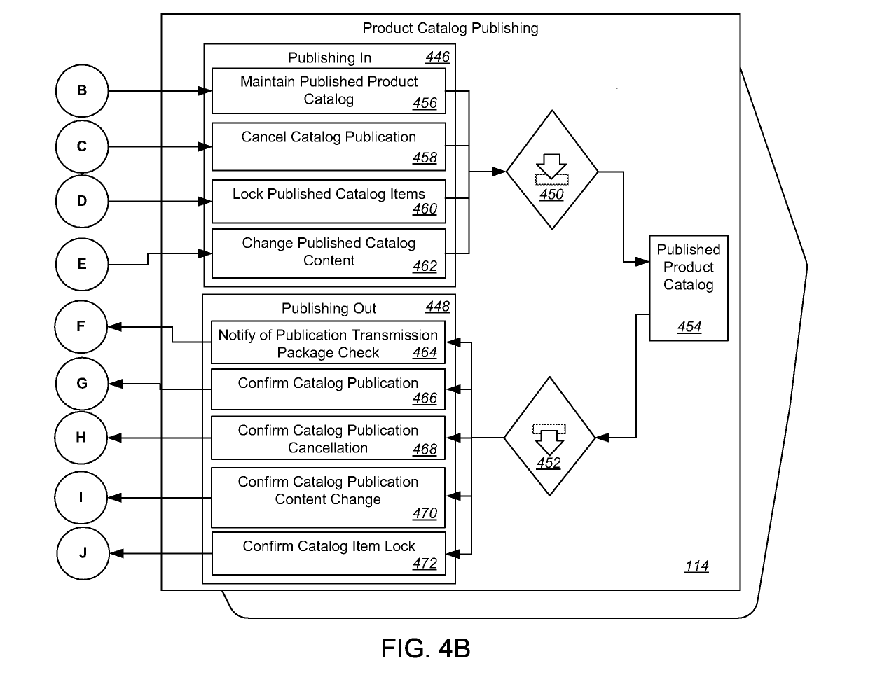

FIGS. 4A and 4B are block diagrams collectively showing example interactions between the Product Catalog Authoring process component 110 and the Product Catalog Publishing process component 114 in the architectural design of FIG. 1. The interactions start when an internal publishing approval status is set to “approved.”

As shown in FIG. 4, the Product Catalog Authoring process component 110 includes a Product Catalog business object 322. The Product Catalog business object 322 represents a structured directory of catalog items, where each catalog item represents and may provide information about a product.

The Product Catalog business object 322 uses a Request Publication from Product Catalog to Product Catalog Publishing outbound process agent 402 to invoke a Request Catalog Publication operation 410. The Request Catalog Publication operation 410 requests a catalog publication system to publish a new catalog or to update or delete an already published catalog. The request from operation 410 may be transmitted in several packages. The Request Catalog Publication operation 410 sends a Catalog Publication Request message 428 to process component 114. The message 428 is a request to publish a new or changed catalog or to delete an already published catalog.

The Request Publication from Product Catalog to Product Catalog Publishing outbound process agent 402 can also invoke a Request Catalog Publication Cancellation operation 412. The operation 412 may request the cancellation of processing a transmission request. The operation 412 may also restore an earlier published state of the catalog. The operation 412 may also send information that the Product Catalog Authoring process component 110 will send no further packages for the transmission. The Request Catalog Publication Cancellation operation 412 sends a Catalog Publication Transmission Cancellation Request message 430 to process component 114. The Catalog Publication Transmission Cancellation Request message 430 may request the cancellation of the transmission of a catalog and the restoration of an earlier published state of the catalog.

The outbound process agent 402 can also invoke a Request Catalog Item Lock operation 414. The operation 414 may request transmission to lock single items of the published catalog. The unlocking of an unpublished catalog item may indicate that the unpublished catalog item should not be published. The unlocking of an already published catalog item may indicate that the publication of the already published item should be revoked. The Request Catalog Item Lock operation 414 sends a Catalog Item Lock Request message 432 to process component 114. The Catalog Item Lock Request message 432 is a request to lock single items of the catalog contained in the catalog publication transmission.

The outbound process agent 402 can also invoke a Request Catalog Publication Content Change operation 416. The operation 416 can request a change, addition, or deletion of catalog items in the published catalog. The Request Catalog Publication Content Change operation 416 sends a Catalog Publication Transmission Content Change Request message 434 to process component 114. The Catalog Publication Transmission Content Change Request message 434 is a request to change, create or delete catalog items contained in the catalog publication transmission. The operations 410, 412, 414 and 416 are all included in a Publishing Out interface 406.

As shown in FIG. 4B, the messages 428, 430, 432, and 434 are received by the Product Catalog Publishing process component 114. The Catalog Publication Request message 428 is received by a Maintain Published Product Catalog operation 456. The Maintain Published Product Catalog operation 456 may update a published catalog, and in some implementations, may use several packages to transmit the catalog. The update may be tentative until the last package has been successfully received and processed.

The Catalog Publication Transmission Cancellation Request message 430 is received by a Cancel Catalog Publication operation 458. The Cancel Catalog Publication operation 458 may cancel the transmission of a catalog update in several packages. The Catalog Item Lock Request message 432 is received by a Lock Published Catalog Items operation 460, which is operative to lock a set of items in a published catalog. The Catalog Publication Transmission Content Change Request message 434 is received by a Change Published Catalog Content operation 462. The Change Published Catalog Content operation 462 may update the content of an already published catalog. In some implementations the operation 462 may be stateless, meaning that subsequent operation calls are treated as independent, in contrast to a transmission of a catalog in packages.

The Maintain Published Product Catalog operation 456, the Cancel Catalog Publication operation 458, the Lock Published Catalog Items operation 460, and the Change Published Catalog Content operation 462 are all included in a Publishing In interface 446. The operations 456, 458, 460, and 462 may each use a Maintain Published Product Catalog inbound process agent 450 to update a Published Product Catalog business object 454. The Published Product Catalog business object 454 represents a version of a product catalog that has been released for access by, or exchange with, the target group for which the contents of the product catalog have been tailored.

A Notify of Product Catalog Publication Status outbound process agent 452 may be used to notify Product Catalog Authoring process component 110 that a catalog has been updated as a consequence of a publication request. The Published Product Catalog business object 454 uses the Notify of Product Catalog Publication Status outbound process agent 452 to invoke a Notify of Publication Transmission Package Check operation 464. The operation 464 confirms the reception of a catalog transmission package and the validity of its content to the original sender of a request to publish a catalog. The operation 464 sends the confirmation as a catalog publication that includes one or more packages. The Notify of Publication Transmission Package Check operation 464 sends a Catalog Publication Transmission Package Notification message 436 (FIG. 4A) to Product Catalog Authoring process component 110. The Catalog Publication Transmission Package Notification message 436 is the notification of the Catalog Publishing to the Catalog Authoring about the reception of a package of a catalog publication transmission and information about the validity of the package's content.

The Notify of Product Catalog Publication Status outbound process agent 452 can also invoke a Confirm Catalog Publication operation 466. The Confirm Catalog Publication operation 466 confirms to the sender of a catalog publication transmission whether the publication or deletion of the catalog as requested was successful. The operation 466 sends a Catalog Publication Confirmation message 438 (FIG. 4A) to Product Catalog Authoring process component 110. The Catalog Publication Confirmation message 438 indicates whether or not the publication or deletion of a catalog requested by a Catalog Publication Request 428 was successful.

The Notify of Product Catalog Publication Status outbound process agent 452 can also invoke a Confirm Catalog Publication Cancellation operation 468. The Confirm Catalog Publication Cancellation operation 468 confirms to the sender of a catalog publication transmission and a subsequent request to cancel the publication whether the transmission has been cancelled successfully. The Confirm Catalog Publication Cancellation operation 468 sends a Catalog Publication Transmission Cancellation Confirmation message 440 (FIG. 4A) to Product Catalog Authoring process component 110. The Catalog Publication Transmission Cancellation Confirmation message 440 indicates whether the transmission of a catalog has been cancelled successfully and whether an earlier published state of a catalog has been restored.

The outbound process agent 452 can also invoke a Confirm Catalog Publication Content Change operation 470. The operation 470 sends a Catalog Publication Transmission Content Change Confirmation message 442 (FIG. 4A) to Product Catalog Authoring process component 110. The Catalog Publication Transmission Content Change Confirmation message 442 confirms whether or not catalog items contained in the catalog publication transmission could be changed, created or deleted as requested by a Catalog Publication Transmission Content Change Request message 434.

The outbound process agent 452 can also invoke a Confirm Catalog Item Lock operation 472. The Confirm Catalog Item Lock operation 472 sends a Catalog Item Lock Confirmation message 444 (FIG. 4A) to Product Catalog Authoring process component 110. The Catalog Item Lock Confirmation message 444 confirms whether items of the catalog contained in the catalog publication transmission could be locked. The Notify of Publication Transmission Package Check operation 464, the Confirm Catalog Publication operation 466, the Confirm Catalog Publication Cancellation operation 468, the Confirm Catalog Publication Content Change operation 470 and the Confirm Catalog Item Lock operation 472 are all included in a Publishing Out interface 448. The Publishing In interface 448 is included in the Product Catalog Publishing process component 114.

As shown in FIG. 4A, the messages 436, 438, 440, 442, and 444 are received by the Product Catalog Authoring process component 110. The message 436 is received by the Change Transmission Status operation 418. The Change Transmission Status operation 418 updates the status of a previously-sent catalog publication transmission package, for example as part of a request to publish a catalog, and in this way, operation 418 may update the progress information about an ongoing catalog publication transmission.

The message 438 is received by the Change Publication Status operation 420. The Change Publication Status operation 420 sets the result status of an ongoing catalog publication transmission, for example, as a consequence of an earlier request to publish a catalog. The message 440 is received by the Change Catalog based on Publication Cancellation operation 422. The Change Catalog based on Publication Cancellation operation 422 updates the result status of a request to cancel an ongoing catalog publication transmission.

The message 442 is received by the Change Catalog based on Content Change Publication Status operation 424. The operation 424 changes one or more catalogs based on a content change or a publication status change. The message 444 is received by the Change Catalog based on Item Lock Status operation 426. The operations 418, 420, 422, 424, and 426 are all included in a Publishing In interface 408. The operations 418, 420, 422, 424, and 426 may each use a Change Product Catalog based on Published Product Catalog inbound process agent 404 to update the Product Catalog business object 322.

### Interactions Between Process Components “Product Catalog Authoring” and “Product Catalog Authoring at Customer”

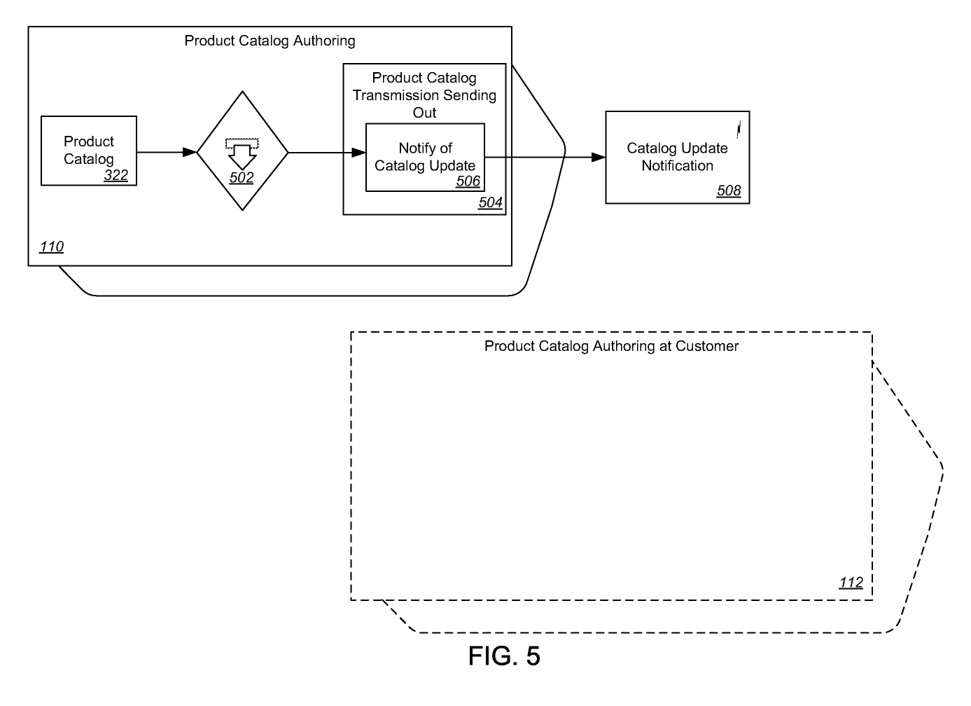

FIG. 5 is a block diagram showing interactions between the Product Catalog Authoring process component 110 and the Product Catalog Authoring at Customer processing component 112 in the architectural design of FIG. 1. The interaction starts with the release of a catalog for publication to a customer.

As shown in FIG. 5, the Product Catalog Authoring processing component 110 includes a Product Catalog business object 322. The Product Catalog business object 322 uses a Notify of Publication from Product Catalog to Customer outbound process agent 502 to invoke a Notify of Catalog Update operation 506. The Notify of Catalog Update operation 506 is included in a Product Catalog Transmission Sending Out interface 504. The Notify of Catalog Update operation 506 notifies an external party, such as a customer, about catalog publication that includes a new catalog or an update of a previously published catalog. The operation 506 generates and sends a Catalog Update Notification message 508 to the Product Catalog Authoring at Customer processing component 112.

Interactions between Process Components “Product Catalog Authoring at Supplier” and “Product Catalog Authoring”

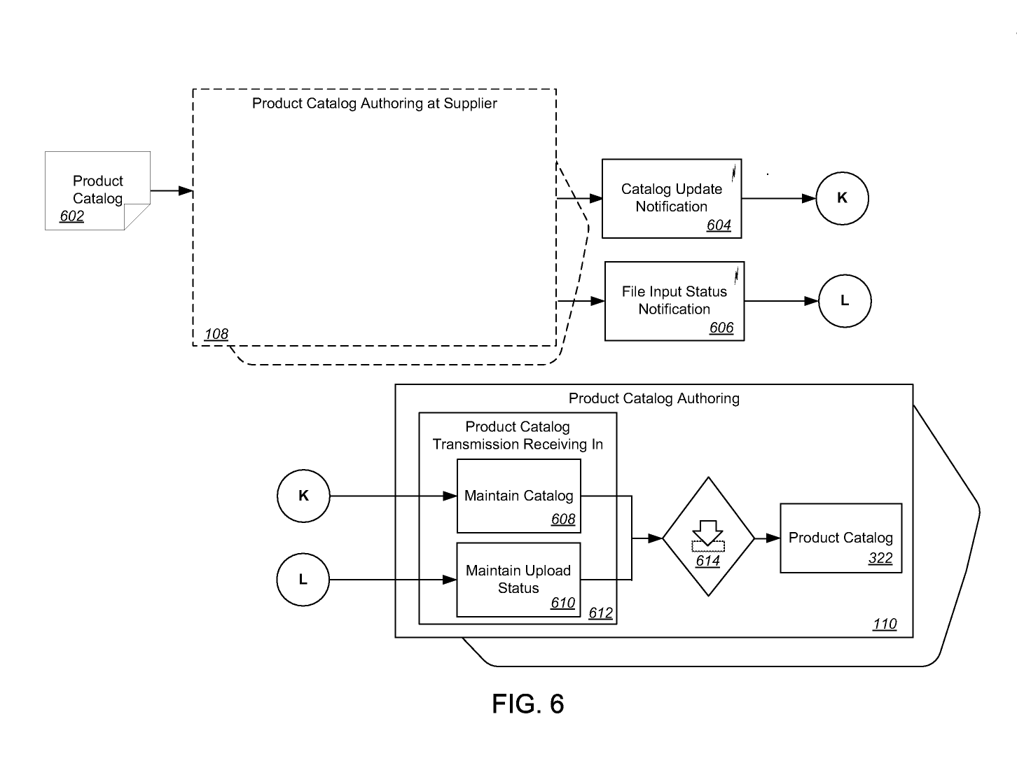

FIG. 6 is a block diagram showing interactions between the Product Catalog Authoring at Supplier process component 108 and the Product Catalog Authoring process component 110 in the architectural design of FIG. 1.

As shown in FIG. 6, the Product Catalog Authoring at Supplier process component 108 receives information from a Product Catalog communication channel template 602. The communication channel template 602 may provide information from an external party, such as a customer, about a catalog publication, which includes a new catalog or an update of a previously published catalog. The Product Catalog Authoring at Supplier process component 108 may send a Catalog Update Notification message 604 or a File Input Status Notification message 606 to the Product Catalog Authoring process component 110.

The Catalog Update Notification message 604 is a notification from an external party, such as a customer, about catalog publication that includes a new catalog or an update of a previously published catalog. The File Input Status Notification message 606 is a notification about the status of a file upload.

A Maintain Catalog operation 608 receives the Catalog Update Notification message 604. A Maintain Upload Status operation 610 receives the File Input Status Notification message 606. The operations 608 and 610 are included in Product Catalog Transmission Receiving In interface 612. The operations 608 and 610 use a Maintain Product Catalog inbound process agent 614 to update the Product Catalog business object 322.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
a product catalog authoring process component that creates and edits a product catalog;
a product catalog publishing process component that provides a released product catalog in electronic form; and
a purchasing contract processing process component that creates and maintains purchasing contracts; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the product catalog authoring process component and the product catalog publishing process component;
the product catalog authoring process component and a product catalog authoring at supplier process component;
the purchasing contract processing process component and the product catalog authoring process component; and
a product catalog authoring at customer process component and the product catalog authoring process component.

2. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

3. The product of claim 2, wherein the deployment units comprise:
a purchasing deployment unit that includes the purchasing contract processing process component;
a catalog authoring deployment unit that includes the product catalog authoring process component; and
a catalog publishing deployment unit that includes the product catalog publishing process component.

4. The product of claim 1, wherein:
each of the process components includes one or more business objects; and
none of the business objects of any one of the process components interacts directly with any of the business objects included in any of the other process components.

5. The product of claim 4, wherein the business objects comprise a business process object.

6. The product of claim 4, wherein none of the business objects included in any one of the process components is included in any of the other process components.

7. The product of claim 1, further comprising a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

8. The product of claim 7, wherein the inbound process agents comprise a first inbound process agent operable to start the execution of a business process step requested in a first inbound message by creating or updating one or more business object instances.

9. The product of claim 7, wherein the outbound process agents comprise a first asynchronous outbound process agent that is called after a business object that is associated with the first outbound process agent changes.

10. The product of claim 1, wherein the operations comprise synchronous and asynchronous operations.

11. A system, comprising:
a computer system comprising one or more hardware platforms for executing a computer software application;
a plurality of process components, each of the process components being a package of software implementing a respective and distinct business process, the plurality of process components including:
a product catalog authoring process component that creates and edits a product catalog;
a product catalog publishing process component that provides a released product catalog in electronic form; and
a purchasing contract processing process component that creates and maintains purchasing contracts; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the product catalog authoring process component and the product catalog publishing process component;
the product catalog authoring process component and a product catalog authoring at supplier process component;
the purchasing contract processing process component and the product catalog authoring process component; and
a product catalog authoring at customer process component and the product catalog authoring process component.

12. The system of claim 11, wherein:
each of the process components includes one or more business objects; and
none of the business objects of any one of the process components interacts directly with any of the business objects included in any of the other process components.

13. The system of claim 11, wherein none of the business objects included in any one of the process components is included in any of the other process components.

14. The system of claim 11, further comprising a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

15. The system of claim 11, the system comprising multiple hardware platforms, wherein:
the product catalog authoring process component is deployed on a first hardware platform;
the product catalog publishing process component is deployed on a second hardware platform; and
the purchasing contract processing process component is deployed on a third hardware platform.

16. The system of claim 15, wherein the first and the second hardware platforms are distinct and separate from each other.

17. A method for developing a computer software application, comprising:
obtaining in a computer system digital data representing an architectural design for a set of processes implementing an end-to-end application process, the design specifying a process component for each process in the set of processes and the design further specifying a set of process component interactions, wherein:
the specified process components include:
a product catalog authoring process component that creates and edits a product catalog;
a product catalog publishing process component that provides a released product catalog in electronic form; and
a purchasing contract processing process component that creates and maintains purchasing contracts; and
the process component interactions include interactions between:
the product catalog authoring process component and the product catalog publishing process component;
the product catalog authoring process component and a product catalog authoring at supplier process component;
the purchasing contract processing process component and the product catalog authoring process component; and
a product catalog authoring at customer process component and the product catalog authoring process component; and
using the design including the specified process components and the specified process component interactions to develop a computer software application to perform the set of processes.

18. The method of claim 17, wherein each process in the set of processes is a business process transforming a defined business input into a defined business outcome.

19. The method of claim 18, wherein obtaining digital data representing the architectural design further comprises editing the design before using the design.
